(19) United States
(12) Patent Application Publication
(10) Pub. No.: US 2020/0151084 A1
(43) Pub. Date: May 14, 2020

(54) INFORMATION PROCESSING APPARATUS, INFORMATION PROCESSING METHOD, AND COMPUTER READABLE MEDIUM

(71) Applicant: Mitsubishi Electric Corporation, Chiyoda-ku, Tokyo (JP)

(72) Inventors: Go HATAKEYAMA, Tokyo (JP); Yuhei KOITO, Tokyo (JP); Satoshi IWABUCHI, CTokyo (JP); Natsuko FUJII, Tokyo (JP); Katsuhide TAKAHASHI, Tokyo (JP)

(73) Assignee: Mitsubishi Electric Corporation, Chiyoda-ku, Tokyo (JP)

(21) Appl. No.: 16/338,565

(22) PCT Filed: Nov. 22, 2016
(86) PCT No.: PCT/JP2016/084617

§ 371 Date: Apr. 1, 2019

(51) Int. Cl. G06F 11/36; G06F 8/30; G06F 8/71

(52) U.S. Cl. CPC G06F 11/3608; G06F 8/30; G06F 11/3664; G06F 8/71; G06F 11/3636

(57) ABSTRACT

A description extraction unit analyzes a source code in which a plurality of execution paths exist, and extracts, on a per execution path basis, a description in the source code that does not affect an execution result even when it is deleted, as a deletable description. An effect calculation unit calculates, on a per execution path basis, a speed performance improvement effect which is an effect of improving the execution speed of the source code in the case of deleting the deletable description from the source code. A rewrite example generation unit generates a rewrite example of the source code which involves deletion of any deletable description from the source code, based on the speed performance improvement effect.

### TECHNICAL FIELD

The present invention relates to improvement of performance of a software program (hereinafter also referred to simply as software).

### BACKGROUND ART

Problems may be found in the execution speed performance of software in the final phase of software development.

On a software development site, a common method is to measure the execution speed of software using a profiler, identify a bottleneck from a measurement result, and solve the identified bottleneck. However, this method cannot be performed unless the software is developed to a stage where the software can be executed.

Therefore, it is required to evaluate the execution speed performance of software at an earlier stage of development to reduce rework in the development.

Patent Literature 1 discloses a method in which static analysis is performed on a software program under development for which an execution environment has not yet been established, so as to predict the execution speed performance from the logic of the software program and automatically suggest improvement points.

Patent Literature 2 discloses a method in which the logic of a software program is separated as an arbitrary block and processing not affecting the output of this block is presented as a deletion candidate.

### CITATION LIST

### Patent Literature

Patent Literature 1: JP 2007-179488 A

Patent Literature 2: JP 2008-176639 A

### SUMMARY OF INVENTION

### Technical Problem

With the technique of Patent Literature 1, it is possible to predict the execution speed performance of a software program by static analysis, and to predict a part to become a bottleneck. However, with the technique of Patent Literature 1, a specific method for solving the predicted bottleneck is not presented to a software developer.

For how to solve bottlenecks in software programs, there is little choice but to depend on ideas based on knowledge and experience of software developers even when using the profiler described above or when using the technique of Patent Literature 1.

Therefore, with the technique of Patent Literature 1, software developers need to spend a large amount of time on consideration for solving bottlenecks.

In the technique of Patent Literature 2, when a software program includes a description not necessarily required for executing a function required of the software program, deletion of this description is suggested to a software developer as a method for achieving improvement in the execution speed performance. That is, the technique of Patent Literature 2 is effective only when the software program includes a description not necessarily required for executing the function.

However, it is rare for software programs to include descriptions not necessarily required for functioning, in other words, inefficient descriptions that deteriorate the execution speed. Therefore, there are not many cases where the technique of Patent Literature 2 premised on existence of such inefficient descriptions can be used to effectively improve the execution speed in actual software program development.

It is a main object of the present invention to present to a software developer a specific method for improving the execution speed performance without affecting an execution result.

### Solution to Problem

An information processing apparatus according to the present invention includes:

a description extraction unit to analyze a source code in which a plurality of execution paths exist, and extract, on a per execution path basis, a description in the source code that does not affect an execution result even when the description is deleted, as a deletable description;

an effect calculation unit to calculate, on a per execution path basis, a speed performance improvement effect which is an effect of improving an execution speed of the source code in a case of deleting the deletable description from the source code; and

a rewrite example generation unit to generate a rewrite example of the source code which involves deletion of any deletable description from the source code, based on the speed performance improvement effect.

### Advantageous Effects of Invention

In the present invention, a rewrite example of a source code which involves deletion of any deletable description from the source code is generated based on a speed performance improvement effect. Therefore, it is possible to present to a software developer a specific example of the software code which improves the execution speed performance without affecting an execution result.

### BRIEF DESCRIPTION OF DRAWINGS

FIG. 1 is a diagram illustrating an example of a functional configuration of an information processing apparatus according to a first embodiment;

FIG. 2 is a flowchart illustrating an operation procedure of an input analysis unit according to the first embodiment;

FIG. 3 is a flowchart illustrating an operation procedure of an output influence analysis unit according to the first embodiment;

FIG. 4 is a diagram illustrating an example of a processing block according to the first embodiment;

FIG. 5 is a diagram illustrating an example of a processing block after deleting deletable descriptions according to the first embodiment;

FIG. 6 is a flowchart illustrating an operation procedure of a processing time estimation unit according to the first embodiment;

FIG. 7 is a flowchart illustrating an operation procedure of an improvement effect estimation unit according to the first embodiment;

FIG. 8 is a flowchart illustrating an operation procedure of a rewrite example generation unit according to the first embodiment; and

FIG. 9 is a diagram illustrating an example of a hardware configuration of the information processing apparatus according to the first embodiment.

### DESCRIPTION OF EMBODIMENTS

### First Embodiment

In this embodiment, an information processing apparatus will be described which can present to a software developer a specific example of a source code to improve the execution speed performance without affecting an execution result.

The information processing apparatus according to this embodiment will be described hereinafter with reference to the drawings. In the following description and the drawings of the embodiment, those with the same reference numeral indicate the same or corresponding part.

***Description of Configuration***

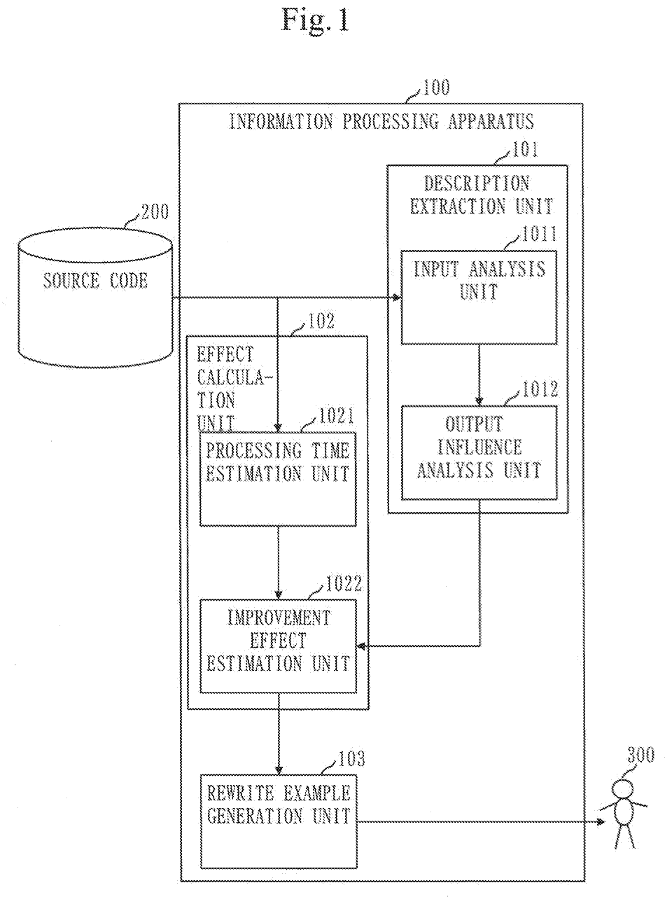

FIG. 1 illustrates an example of a functional configuration of an information processing apparatus 100 according to this embodiment.

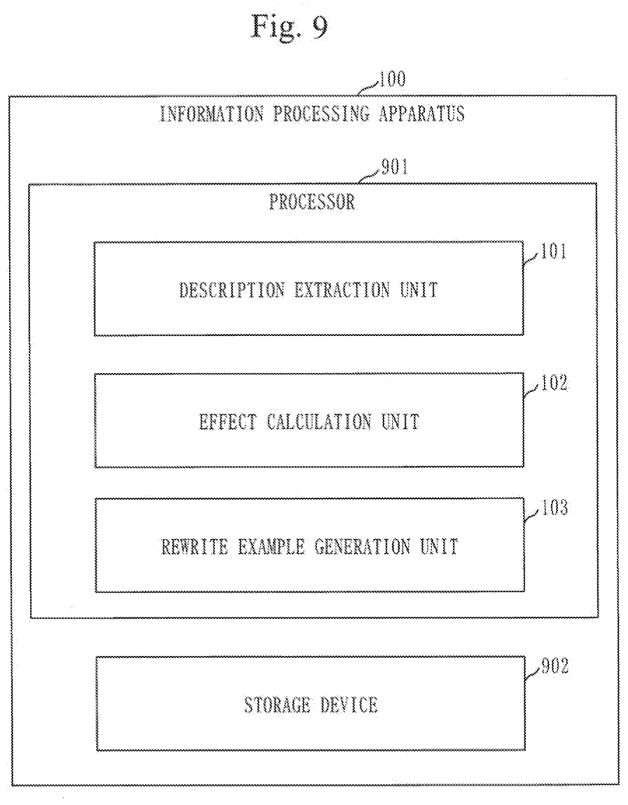

FIG. 9 illustrates an example of a hardware configuration of the information processing apparatus 100 according to this embodiment.

First, the hardware configuration of the information processing apparatus 100 will be described with reference to FIG. 9.

The information processing apparatus 100 according to this embodiment is a computer.

The information processing apparatus 100 has a processor 901 and a storage device 902 as hardware.

The information processing apparatus 100 has a description extraction unit 101, an effect calculation unit 102, and a rewrite example generation unit 103 as a functional configuration.

The storage device 902 stores programs for realizing functions of the description extraction unit 101, the effect calculation unit 102, and the rewrite example generation unit 103.

The processor 901 executes these programs to perform operation of the description extraction unit 101, the effect calculation unit 102, and the rewrite example generation unit 103 to be described later.

FIG. 9 schematically represents a state in which the processor 901 is executing the programs for realizing the functions of the description extraction unit 101, the effect calculation unit 102, and the rewrite example generation unit 103.

The operation performed by the information processing apparatus 100 corresponds to an information processing method and an information processing program.

The functional configuration of the information processing apparatus 100 will now be described with reference to FIG. 1.

As illustrated in FIG. 1, the information processing apparatus 100 is composed of the description extraction unit 101, the effect calculation unit 102, and the rewrite example generation unit 103 which are functional components.

The description extraction unit 101 obtains a source code 200 of a software program. A plurality of execution paths exist in the source code 200.

An execution path is a path traced when the source code 200 is executed. For example, a plurality of execution paths are formed by conditional branch processing or loop processing.

Then, the description extraction unit 101 statically analyzes the source code 200 and extracts, on a per execution path basis, a description in the source code 200 that does not affect an execution result even when it is deleted, as a deletable description.

More specifically, the description extraction unit 101 analyzes value ranges of variables included in the source code 200 and extracts a deletable description based on the analyzed value ranges of variables, on a per execution path basis.

The operation performed by the description extraction unit 101 corresponds to a description extraction process.

The description extraction unit 101 is composed of an input analysis unit 1011 and an output influence analysis unit 1012.

The input analysis unit 1011 analyzes the value ranges of variables included in the source code 200. The output influence analysis unit 1012 extracts a deletable description based on the value ranges of variables analyzed by the input analysis unit 1011.

The operation of the input analysis unit 1011 and the output influence analysis unit 1012 will be described in detail later.

The effect calculation unit 102 calculates, on a per execution path basis, a speed performance improvement effect which is an effect of improving the execution speed of the source code 200 in the case of deleting deletable descriptions from the source code 200.

More specifically, the effect calculation unit 102 calculates, on a per execution path basis, the effect of improving the execution speed of the source code 200 in the case of deleting deletable descriptions from the source code 200, as a first speed performance improvement effect. Further, the effect calculation unit 102 calculates, on a per deletable description basis, the effect of improving the execution speed of the source code 200 in the case of deleting a deletable description from the source code 200 in an execution path including the deletable description, as a second speed performance improvement effect.

The operation performed by the effect calculation unit 102 corresponds to an effect calculation process.

The effect calculation unit 102 is composed of a processing time estimation unit 1021 and an improvement effect estimation unit 1022.

The processing time estimation unit 1021 estimates a processing time for each piece of processing included in the source code 200. Processing is arithmetic processing included in the source code 200. The processing time is a time required for executing the processing.

The improvement effect estimation unit 1022 calculates the speed performance improvement effect based on a result of estimation of the processing time by the processing time estimation unit 1021.

The operation of the processing time estimation unit 1021 and the improvement effect estimation unit 1022 will be described in detail later.

The rewrite example generation unit 103 generates a rewrite example of the source code 200 which involves deletion of any of the deletable descriptions from the source code 200 based on the speed performance improvement effect calculated by the effect calculation unit 102.

More specifically, the rewrite example generation unit 103 generates a rewrite example of the source code 200 based on the first speed performance improvement effect and the second speed performance improvement effect calculated by the effect calculation unit 102.

The rewrite example generation unit 103 may generate a plurality of rewrite examples.

Then, the rewrite example generation unit 103 outputs the generated rewrite example of the source code 200. When generating a plurality of rewrite examples, the rewrite example generation unit 103 outputs the generated rewrite examples in descending order of the speed performance improvement effect. A software developer 300 can check the rewrite examples in descending order of the speed performance improvement effect.

The operation performed by the rewrite example generation unit 103 corresponds to a rewrite example generation process.

The operation of the rewrite example generation unit 103 will be described in detail later.

***Description of Operation***

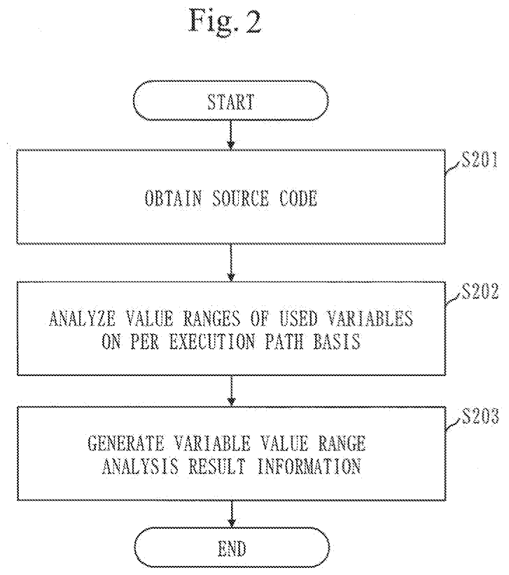

The operation of the input analysis unit 1011 according to this embodiment will now be described with reference to the flowchart of FIG. 2.

In step S201, the input analysis unit 1011 obtains the source code 200. Means to input the source code 200 is not particularly limited. The input analysis unit 1011 stores the obtained source code 200 in the storage device 902, for example.

In step S202, the input analysis unit 1011 statically analyzes the source code obtained in step S201, and the input analysis unit 1011 extracts a plurality of execution paths included in the source code 200. The input analysis unit 1011 may extract all execution paths included in the source code 200 or may extract only some execution paths matching a specific condition.

Then, the input analysis unit 1011 analyzes, on a per execution path basis, value ranges of variables used in an execution path based on conditional branch processing and arithmetic processing in the execution path.

In the execution path, the value range of a variable may change as processing proceeds. In such a case in which the value range of a variable changes, the input analysis unit 1011 analyzes which processing in the execution path is executed when the value range of the variable changes.

In step S203, the input analysis unit 1011 generates variable value range analysis result information indicating a result of analysis in step S202. Specifically, the variable value range analysis result information indicates, for each execution path, the value ranges of variables and points at which the value ranges change.

Then, the input analysis unit 1011 stores the generated variable value range analysis result information in the storage device 902. The input analysis unit 1011 may store the variable value range analysis result information in a storage medium other than the storage device 902.

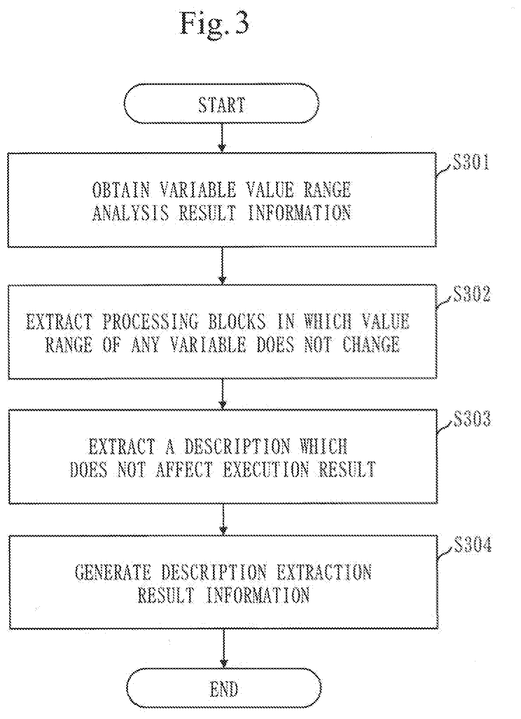

The operation of the output influence analysis unit 1012 according to this embodiment will now be described with reference to the flowchart of FIG. 3.

In step S301, the output influence analysis unit 1012 obtains the variable value range analysis result information generated in step S203. The output influence analysis unit 1012 reads the variable value range analysis result information from the storage device 902, for example.

In step S302, the output influence analysis unit 1012 extracts, for each execution path, a processing block in which the value range of any variable does not change based on the variable value range analysis result information. A processing block is a partial region in the source code 200.

In step S303, from the processing block in which the value range of any variable does not change extracted in step S302, the output influence analysis unit 1012 extracts a description that does not affect an output of the processing block if the value range of each variable is applied. The description extracted in step S303 is a deletable description.

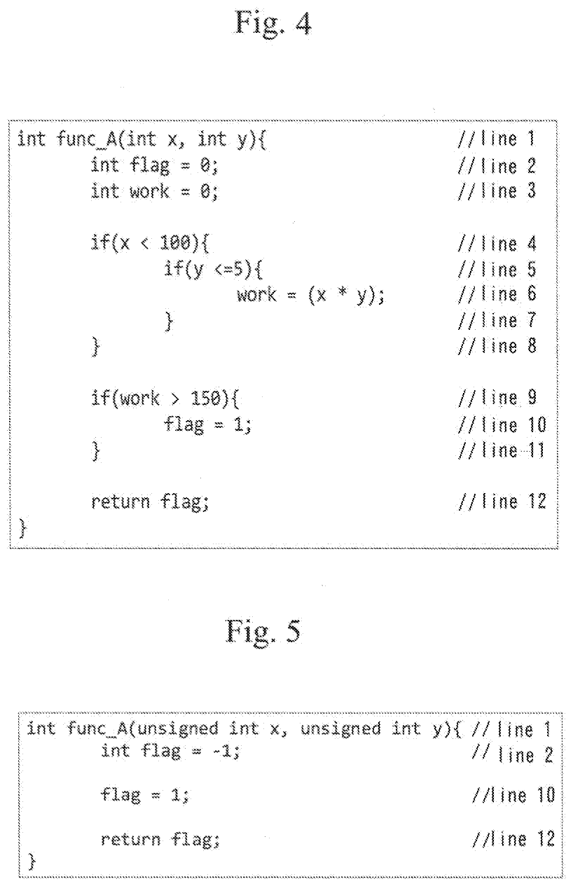

An example of extraction of a description that does not affect the output of the processing block will be described here using an example of the source code illustrated in FIG. 4.

FIG. 4 illustrates an example of a processing block in the source code written in C language which is a programming language.

It is assumed that a function call on line 1 of FIG. 4 is performed in a certain execution path in the source code.

If the variable value range analysis result information indicates that the value range of a variable x is from 0 to less than 100 at the time of performing the function call on line 1 of FIG. 4 in this execution path, the result of a conditional determination on line 4 is always true.

Therefore, even if descriptions on lines 4 to 8 are deleted, the execution result does not change in this execution path.

The processing time estimation unit 1021 extracts the descriptions on lines 4 to 8 as deletable descriptions for this execution path.

If the variable value range analysis result information indicates that the value range of the variable x is from 80 to 90 and the value range of a variable y is from 2 to 4 at the time of performing the function call on line 1 of FIG. 4 in another execution path, the results of conditional determinations on lines 4, 5 and 9 are always true. Therefore, even if descriptions on lines 4, 5, and 9 are deleted, the execution result does not change in this execution path.

If the descriptions on line 4, 5 and 9 can be deleted, a description on line 6 can also be deleted.

The processing time estimation unit 1021 extracts the descriptions on lines 4, 5, 6, and 9 as deletable descriptions for this execution path.

Next, referring back to the flowchart of FIG. 3, in step S304 the output influence analysis unit 1012 generates description extraction result information indicating a result of extraction in step S303. Specifically, the description extraction result information indicates deletable descriptions for each execution path.

Then, the output influence analysis unit 1012 stores the generated description extraction result information in the storage device 902. The output influence analysis unit 1012 may store the description extraction result information in a storage medium other than the storage device 902.

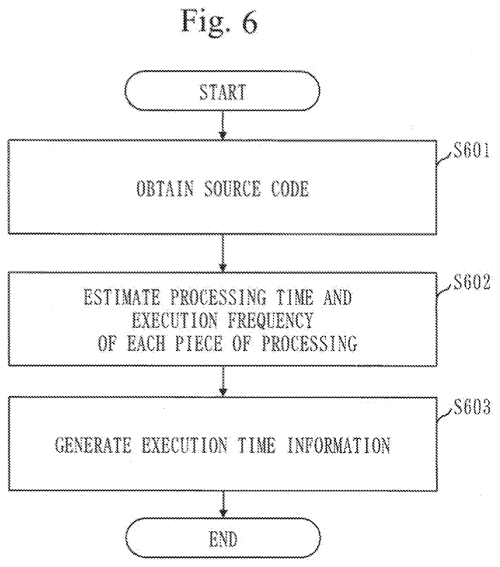

The operation of the processing time estimation unit 1021 according to this embodiment will now be described with reference to the flowchart of FIG. 6.

In step S601, the processing time estimation unit 1021 obtains the source code 200. Means to input the source code 200 is not particularly limited. The processing time estimation unit 1021 reads the source code 200 from the storage device 902, for example.

In step S602, the processing time estimation unit 1021 statically analyzes the source code 200, and estimates the processing time of each piece of processing and the execution frequency of each piece of processing in each execution path, for each piece of processing included in the source code 200.

As described above, processing is arithmetic processing included in the source code 200, and is arithmetic processing defined on each line of lines 1 to 6, 9, 10, and 12 in FIG. 4, for example.

The estimation of the processing time of each piece of processing and the estimation of the execution frequency of each piece of processing are realized, for example, by the procedures disclosed in Patent Literature 1. However, the processing time estimation unit 1021 may estimate the processing time of each piece of processing and estimate the execution frequency of each piece of processing by other procedures.

In step S603, the processing time estimation unit 1021 generates execution time information indicating a result of estimation in step S602. Specifically, the execution time information indicates the processing time of each piece of processing and also the execution frequency of each piece of processing for each execution path.

Then, the processing time estimation unit 1021 stores the generated execution time information in the storage device 902. The processing time estimation unit 1021 may store the execution time information in a storage medium other than the storage device 902.

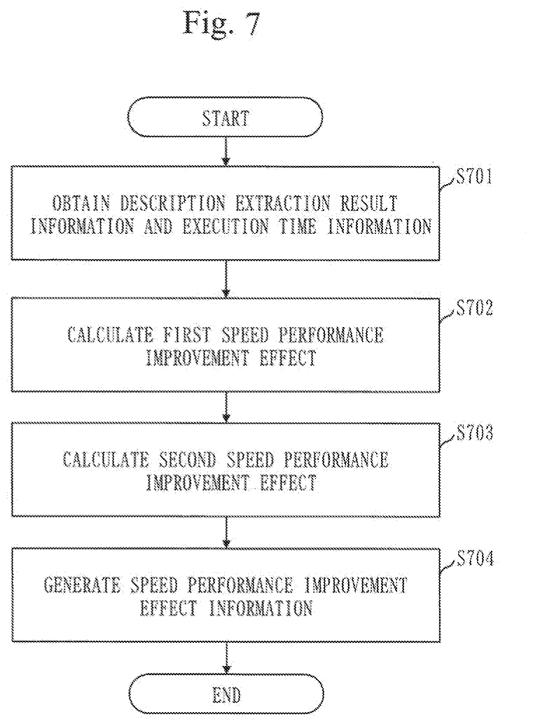

The operation of the improvement effect estimation unit 1022 according to this embodiment will now be described with reference to the flowchart of FIG. 7.

In step S701, the improvement effect estimation unit 1022 obtains the description extraction result information and the execution time information. The improvement effect estimation unit 1022 reads the description extraction result information and the execution time information from the storage device 902, for example.

In step S702, the improvement effect estimation unit 1022 calculates the first speed performance improvement effect. That is, the improvement effect estimation unit 1022 calculates, on a per execution path basis, the effect of improving the execution speed of the source code 200 in the case of deleting deletable descriptions from the source code 200 (first speed performance improvement effect).

More specifically, the improvement effect estimation unit 1022 obtains the deletable descriptions and the execution paths corresponding to the deletable descriptions from the description extraction result information. Next, the improvement effect estimation unit 1022 obtains the processing time and execution frequency of each piece of processing included in each execution path from the execution time information. Then, the improvement effect estimation unit 1022 calculates, for each execution path, (processing time×execution frequency) of each piece of processing included in an individual execution path, and finds the sum of values of (processing time×execution frequency) of all pieces of processing included in the individual execution path (hereinafter referred to as a total time A). The improvement effect estimation unit 1022 also calculates, for each execution path, (processing time×execution frequency) of each piece of processing corresponding to each deletable description included in an individual execution path, and finds the sum of values of (processing time×execution frequency) of all pieces of processing corresponding to the deletable descriptions (hereinafter referred to as a total time B). Then, the improvement effect estimation unit 1022 calculates the first speed performance improvement effect using the total time A and the total time B. For example, the improvement effect estimation unit 1022 calculates the first speed performance improvement effect by (total time A−total time B)±(total time A).

The improvement effect estimation unit 1022 repeats the above procedure for the plurality of execution paths to calculate the first speed performance improvement effect of the plurality of execution paths. That is, the improvement effect estimation unit 1022 calculates the first speed performance improvement effect in the case of deleting the pieces of processing corresponding to the deletable descriptions, for processing blocks which are included in each execution path and are separated at each point at which the value range of a variable changes.

In step S703, the improvement effect estimation unit 1022 calculates the second speed performance improvement effect. That is, the improvement effect estimation unit 1022 calculates, on a per deletable description basis, the effect of improving the execution speed of the source code 200 in the case of deleting a deletable description from the source code 200 in an execution path including the deletable description (second speed performance improvement effect).

More specifically, the improvement effect estimation unit 1022 calculates, for each deletable description, (processing time×execution frequency) of a piece of processing corresponding to an individual deletable description in each execution path including the individual deletable description, and finds the sum of values of (processing time×execution frequency) of all execution paths including the individual deletable description (hereinafter referred to as a total time C). The improvement effect estimation unit 1022 also sums, for each deletable description, the total times A of all the execution paths including an individual deletable description (the time obtained by summing is hereinafter referred to as a total time D). Then, the improvement effect estimation unit 1022 calculates the second speed performance improvement effect using the total time C and the total time D. For example, the improvement effect estimation unit 1022 calculates the second speed performance improvement effect by (total time D−total time C)±(total time D).

In step S704, the improvement effect estimation unit 1022 generates speed performance improvement effect information indicating the first speed performance improvement effect and the second speed performance improvement effect. The speed performance improvement effect information indicates the first speed performance improvement effect for each execution path and the second speed performance improvement effect for each deletable description.

Then, the improvement effect estimation unit 1022 stores the generated speed performance improvement effect information in the storage device 902. The improvement effect estimation unit 1022 may store the speed performance improvement effect information in a storage medium other than the storage device 902.

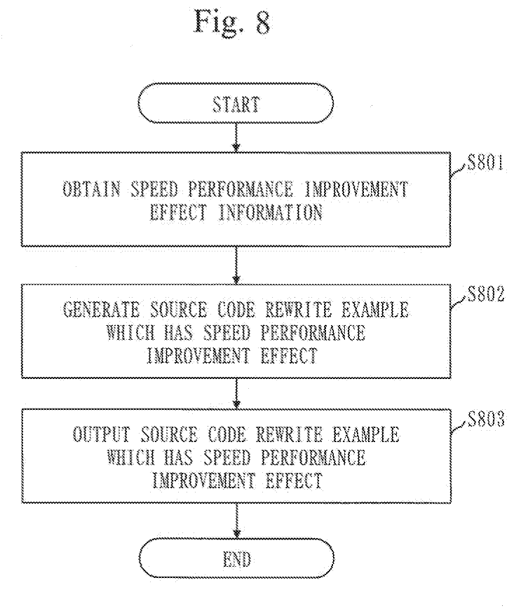

The operation of the rewrite example generation unit 103 according to this embodiment will now be described with reference to the flowchart of FIG. 8.

In step S801, the rewrite example generation unit 103 obtains the source code 200 and the speed performance improvement effect information. The rewrite example generation unit 103 reads the source code 200 and the speed performance improvement effect information from the storage device 902, for example.

In step S802, the rewrite example generation unit 103 generates a rewrite example of the source code 200 which involves deletion of any of the deletable descriptions based on the first speed performance improvement effect and the second speed performance improvement effect.

The rewrite example generation unit 103 generates, for example, a rewrite example of the source code 200 which maximizes the first speed performance improvement effect, a rewrite example of the source code 200 which maximizes the second speed performance improvement effect, and a rewrite example of the source code 200 which maximizes the sum of the first speed performance improvement effect and the second speed performance improvement effect.

In step S803, the rewrite example generation unit 103 outputs the rewrite examples of the source code 200 generated in step S802, and also outputs the execution path to be rewritten and the speed performance improvement effect for each rewrite example. The rewrite example generation unit 103 outputs the rewrite examples of the source code 200 in descending order of the speed performance improvement effect, for example. The output order of the rewrite examples of the source code 200 can be set arbitrarily.

FIG. 5 illustrates a rewrite example of the source code 200 to be presented to the software developer.

FIG. 5 is the rewrite example in which lines 3 to 9 and 11 are deleted from the processing block of FIG. 4. In the example of FIG. 5, it is possible to delete three pieces of conditional determination processing written on lines 4, 5 and 9 and one piece of integration processing and one piece of assignment processing written on line 6 of FIG. 4.

### Description of Effect of Embodiment

According to this embodiment, a user (software developer) can obtain a specific source code rewrite plan for improving the execution speed performance of a software program without considering by the user itself the influence on the program due to a change in the source code. Therefore, the execution speed performance of the software program can be efficiently improved.

### REFERENCE SIGNS LIST

100: information processing apparatus, 101: description extraction unit, 102: effect calculation unit, 103: rewrite example generation unit, 1011: input analysis unit, 1012: output influence analysis unit, 1021: processing time estimation unit, 1022: improvement effect estimation unit, 200: source code, 300: software developer, 901: processor, 902: storage device

1. An information processing apparatus comprising:
processing circuitry to:
analyze a source code in which a plurality of execution paths exist, and extract, on a per execution path basis, a description in the source code that does not affect an execution result even when the description is deleted, as a deletable description;
calculate, on a per execution path basis, a speed performance improvement effect which is an effect of improving an execution speed of the source code in a case of deleting the deletable description from the source code; and
generate a rewrite example of the source code which involves deletion of any deletable description from the source code, based on the speed performance improvement effect.

2. The information processing apparatus according to claim 1,
wherein
the processing circuitry calculates, on a per execution path basis, the effect of improving the execution speed of the source code in the case of deleting the deletable description from the source code, as a first speed performance improvement effect, and also calculates, on a per deletable description basis, an effect of improving the execution speed of the source code in a case of deleting the deletable description from the source code in an execution path including the deletable description, as a second speed performance improvement effect, and
generates the rewrite example of the source code based on the first speed performance improvement effect and the second speed performance improvement effect.

3. The information processing apparatus according to claim 1,
wherein
the processing circuitry outputs the generated rewrite example of the source code.

4. The information processing apparatus according to claim 1,
wherein
the processing circuitry generates a plurality of rewrite examples of the source code.

5. The information processing apparatus according to claim 4,
wherein
the processing circuitry outputs the generated plurality of rewrite examples of the source code in descending order of the speed performance improvement effect.

6. The information processing apparatus according to claim 1, wherein
the processing circuitry analyzes a value range of a variable included in the source code and extracts the deletable description based on the analyzed value range of the variable, on a per execution path basis.

7. An information processing method comprising:
analyzing a source code in which a plurality of execution paths exist, and extracting, on a per execution path basis, a description in the source code that does not affect an execution result even when the description is deleted, as a deletable description;
calculating, on a per execution path basis, a speed performance improvement effect which is an effect of improving an execution speed of the source code in a case of deleting the deletable description from the source code; and
generating a rewrite example of the source code which involves deletion of any deletable description from the source code, based on the speed performance improvement effect.

8. A non-transitory computer readable medium storing an information processing program for causing a computer to execute:
a description extraction process to analyze a source code in which a plurality of execution paths exist, and extract, on a per execution path basis, a description in the source code that does not affect an execution result even when the description is deleted, as a deletable description;
an effect calculation process to calculate, on a per execution path basis, a speed performance improvement effect which is an effect of improving an execution speed of the source code in a case of deleting the deletable description from the source code; and
a rewrite example generation process to generate a rewrite example of the source code which involves deletion of any deletable description from the source code, based on the speed performance improvement effect.
